(19) United States
(12) Patent Application Publication
(10) Pub. No.: US 2014/0025574 A1
(43) Pub. Date: Jan. 23, 2014

(54) READABLE INDICIA FOR A PAYMENT CLAIM

(71) Applicants: David M. Grigg, Rock Hill, SC (US); Glenn Grossman, Matthews, NC (US); Matthew A. Calman, Charlotte, NC (US); Susan Smith Thomas, Gastonia, NC (US); Peter John Bertanzetti, Charlotte, NC (US)

(72) Inventors: David M. Grigg, Rock Hill, SC (US); Glenn Grossman, Matthews, NC (US); Matthew A. Calman, Charlotte, NC (US); Susan Smith Thomas, Gastonia, NC (US); Peter John Bertanzetti, Charlotte, NC (US)

(73) Assignee: Bank of America Corporation, Charlotte, NC (US)

(21) Appl. No.: 13/554,108

(22) Filed: Jul. 20, 2012

(51) Int. Cl. G06Q 20/40

(52) U.S. Cl. 705/44

(57) ABSTRACT

Embodiments of the invention are directed to systems, methods and computer program products for processing readable indicia for a payment claim. An exemplary system is configured to: receive information associated with readable indicia associated with a payment claim; receive authentication credentials associated with the payment claim; and process the readable indicia and the authentication credentials to authorize a payment associated with the payment claim.

### BACKGROUND

Sometimes, a payment associated with a payment claim may be received by an unintended recipient. There is a need to ensure that a payment associated with a payment claim is received by the intended recipient.

### BRIEF SUMMARY

Embodiments of the invention are directed to systems, methods and computer program products for processing readable indicia for a payment claim. An exemplary system is configured to: receive information associated with readable indicia associated with a payment claim; receive authentication credentials associated with the payment claim; and process the readable indicia and the authentication credentials to authorize a payment associated with the payment claim.

In some embodiments, the readable indicia comprises a Quick Response (QR) code.

In some embodiments, the readable indicia is comprised in a tag that transmits information wirelessly.

In some embodiments, the merchant is an insurance entity.

In some embodiments, the apparatus comprises a portable mobile communication apparatus that comprises an image-capturing component, and wherein an image of the readable indicia is captured by the portable mobile communication apparatus.

In some embodiments, the processing occurs either inside or outside the portable mobile communication apparatus.

In some embodiments, the authentication credentials are input by a user of the portable mobile communication apparatus.

In some embodiments, the readable indicia comprises at least one of electronic readable indicia or physical readable indicia.

In some embodiments, when the readable indicia comprises electronic readable indicia, and the electronic readable indicia is generated dynamically based on user input.

In some embodiments, the authentication credentials are first authentication credentials, and second authentication credentials are comprised in the readable indicia.

In some embodiments, the module is further configured to: extract the second authentication credentials from the readable indicia; and determine whether the first authentication credentials match the second authentication credentials.

In some embodiments, the module is configured to determine whether the authentication credentials match second authentication credentials accessed by the apparatus.

In some embodiments, the module is further configured to initiate an authentication prompt for receiving the authentication credentials in response to receiving the information associated with the readable indicia.

In some embodiments, the module is further configured to: extract a link from the readable indicia; and initiate a user interface associated with the link.

In some embodiments, the module is further configured to initiate issuance of the payment associated with the payment claim to an account or an alias.

In some embodiments, the payment claim was previously submitted by a user to the merchant.

In some embodiments, the payment is issued as an electronic stored value card.

In some embodiments, a method is provided for processing readable indicia for a payment claim. The method comprises: receiving information associated with readable indicia associated with a payment claim; receiving authentication credentials associated with the payment claim; and processing the readable indicia and the authentication credentials to authorize a payment associated with the payment claim.

In some embodiments, a computer program product is provided for processing readable indicia for a payment claim. The computer program product comprises a non-transitory computer-readable medium comprising a set of codes for causing a computer to: receive information associated with readable indicia associated with a payment claim; receive authentication credentials associated with the payment claim; and process the readable indicia and the authentication credentials to authorize a payment associated with the payment claim.

### BRIEF DESCRIPTION OF THE DRAWINGS

Having thus described embodiments of the invention in general terms, reference will now be made to the accompanying drawings, where:

FIG. 1 is a flowchart illustrating a general process flow for processing readable indicia for a payment claim, in accordance with embodiments of the present invention; and

FIG. 2 is a block diagram illustrating technical components of a system for processing readable indicia for a payment claim, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for processing readable indicia for a payment claim. The invention ensures that the payment associated with the payment claim is not received or redeemed by an unintended recipient. As used herein, the readable indicia comprises a code (e.g., barcode, Quick Response (QR) code, etc.).

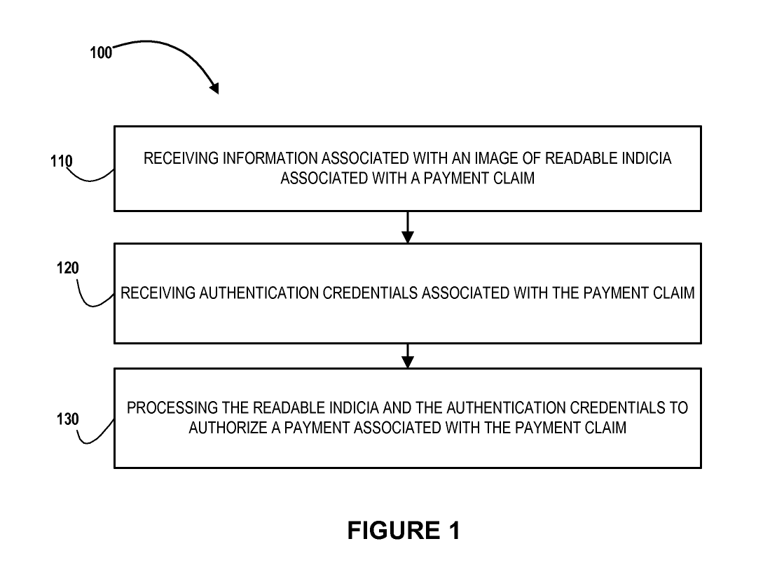

Referring now to FIG. 1, a general process flow 100 is provided for processing readable indicia for a payment claim. At block 110, the method comprises receiving information associated with readable indicia associated with a payment claim. The payment claim may be a claim that was previously submitted by a user to a merchant. In response to submitting the payment claim to the merchant, readable indicia may be received by the user from the merchant (e.g., an insurance entity) either in physical form (e.g., on paper) or in electronic form (e.g., via email, text or multimedia message, etc.). In some embodiments, the readable indicia comprises visual indicia, e.g., a barcode, a Quick Response (QR) code, etc. The readable indicia may comprises any one-dimensional or two-dimensional code. The invention is not limited to the merchant being an insurance entity. In embodiments where the readable indicia is in electronic form, the readable indicia may be dynamically generated after the user selects an option to view the readable indicia (e.g., on the user's portable mobile communication device).

In some embodiments, a user may answer a series of questions (e.g., a feedback form) at a store kiosk. Once the user has completed answering the questions, the store kiosk presents readable indicia. The user may receive information associated with the presented readable indicia using a portable mobile communication device.

In some embodiments, the payment may be a payment from a first user to a second user. The first user may present readable indicia on the first user's mobile device or may issue readable indicia to the second user on a physical medium (e.g., paper). The readable indicia may represent a payment of an amount of funds. The second user may receive information associated with the presented readable indicia using the second user's portable mobile communication device. Therefore, as used herein, a merchant may comprise an individual.

As described herein, a user may use a portable mobile communication device or apparatus (“mobile device”) that comprises an image-capturing component (e.g., a camera) to capture the image of the readable indicia. In some embodiments, this readable indicia is stored in the mobile device. In other embodiments, this readable indicia is automatically transmitted to an external server.

The readable indicia may comprise any indicia, visual or non-visual, where information associated with the indicia is receivable or readable (e.g., scannable) by the mobile device. For example, the readable indicia is comprised in a tag (e.g., radio frequency identification (RFID) tag, near field communication (NFC) tag, etc.). A user may bring a mobile device in close proximity to the tag in order to receive information (e.g., readable indicia) associated with the tag.

In some embodiments, the readable indicia may be processed by at least one of the mobile device or the external server to determine a link (e.g., a hyperlink) associated with the readable indicia. The user interface of the mobile device may present the link and may prompt the user to visit the link. The link may transport the user to a user interface page for entering authentication credentials. Prior to enabling the user to enter the authentication credentials, one or more mobile interface pages of advertisements may be presented to the user.

At block 120, the method comprises receiving authentication credentials associated with the payment claim. In some embodiments, in response to receiving the readable indicia, the mobile device initiates an authentication prompt (e.g., at the link described above) for receiving the authentication credentials from the user. For example, the authentication prompt may comprise a prompt or challenge question for which the user knows the answer. These authentication credentials may have been previously received by the user from the merchant separately from the readable indicia. For example, the merchant may have sent a personal identification number (“PIN”) code to the user via mail, email, text or multimedia message, etc. As a further example, the user may have previously logged onto the merchant's website in order to set up authentication credentials for the payment claim.

Subsequently, the user inputs authentication credentials onto a user interface of the mobile device. In some embodiments, this input may comprise entering a password. In some embodiments, this input may comprise entering an alias. For example, the alias may comprise a phone number, email address, or social networking identification information associated with the user. In other embodiments, this input may comprise entering an answer to a question. In still other embodiments, this input may comprise selecting a picture. In some embodiments, the received authentication credentials are stored in the mobile device. In other embodiments, the received authentication credentials are automatically transmitted to an external server.

At block 130, the method comprises processing the authentication credentials (and/or the readable indicia) to authorize or initiate a payment associated with the payment claim. In embodiments where the authentication credentials (and/or the readable indicia) are stored in the mobile device, the processing of the authentication credentials (and/or the readable indicia) occurs in the mobile device. In embodiments where the authentication credentials (and/or the readable indicia) are transmitted to an external server, the processing of the authentication credentials occurs outside the mobile device, i.e., at the external server. The processing comprises comparing the authentication credentials (and/or information associated with the readable indicia) to information stored in at least one of the mobile device or the external server to determine whether to initiate issuance of a payment associated with the payment claim.

In some embodiments, authentication credentials are comprised in the readable indicia. Therefore, the authentication credentials input by the user are compared to the authentication credentials extracted from the readable indicia. In other embodiments, the authentication credentials are not comprised in the readable indicia. In such embodiments, the authentication credentials input by the user are compared to information (e.g., authentication credentials) stored in at least one of the mobile device or external server or accessed by at least one of the mobile device or external server from an external datastore.

If the mobile device or the external server determines a match between the authentication credentials input by the user and the authentication credentials either extracted from the readable indicia or stored in at least one of the mobile device or external server, the payment associated with the payment claim is authorized or initiated for receipt or redemption. Therefore, either the payment is automatically transmitted to a payment account (e.g., a pre-selected financial institution account) associated with the user, or the user enters details associated with the user's payment account to execute the process of receiving or redeeming the payment associated with the payment claim. In alternate embodiments, the payment associated with the payment claim is authorized or initiated for receipt or redemption without executing the authentication step described herein. In some embodiments, prior to enabling the user to select an account or input account information, one or more mobile interface pages of advertisements may be presented to the user.

In other embodiments, after the user authenticates himself or herself, the user chooses from a list of stored value cards associated with different merchants. The amount of payment claim is converted to a stored value card associated with the selected merchant. The stored value card may be deposited into the user's mobile wallet. Alternatively, the stored value card may be mailed to the user. Therefore, the user receives the payment without providing the user's account information to the merchant. In some embodiments, the merchant may provide an incentive to the user for receiving payment via a stored value card. For example, the merchant may add a predetermined amount (e.g., 1%) to the payment if the user chooses this method of receiving the payment. In some embodiments, prior to enabling the user to select a stored value card, one or more mobile interface pages of advertisements may be presented to the user.

In other embodiments, after the user authenticates himself or herself, the user provides an alias so that the merchant can send the payment to the alias. For example, the alias may comprise a phone number, email address, or social networking identification information associated with the user. Therefore, the user may have pre-registered the user's alias with the financial institution associated with the user's account. Therefore, when the merchant sends the payment to the alias, the financial institution receives the payment, interprets the alias, and forwards the payment to the user's account. Therefore, the user receives the payment without providing the user's account information to the merchant. In some embodiments, the merchant may provide an incentive to the user for receiving payment via alias. For example, the merchant may add a predetermined amount (e.g., 0.5%) to the payment if the user chooses this method of receiving the payment. In some embodiments, prior to enabling the user to provide an alias, one or more mobile interface pages of advertisements may be presented to the user.

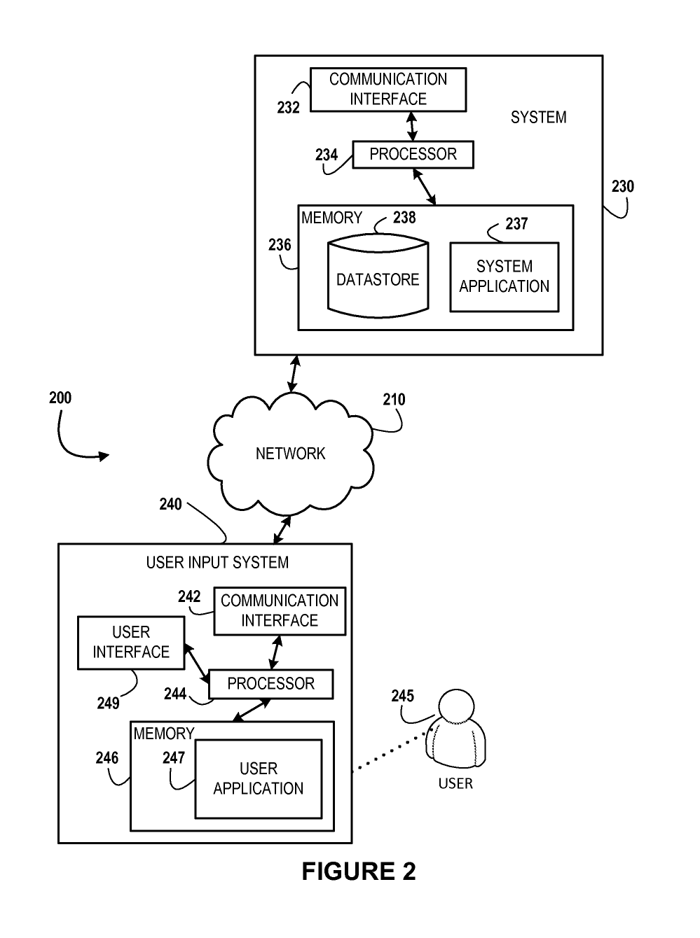

Referring now to FIG. 2, FIG. 2 presents an exemplary block diagram of the system environment 200 for implementing the process flow 100 described in FIG. 1, in accordance with embodiments of the present invention. As illustrated, the system environment 200 includes a network 210, a system 230, and a user input system 240. Also shown in FIG. 2 is a user 245 of the user input system 240. The user input system 240 may be a mobile device described herein. The user 245 may be a person who uses the user input system 240 to execute a user application 247. The system 230 may be the external server described herein. The user application 247 and/or the system application 237 may incorporate one or more parts of the process flow 100 or any other function described herein.

As shown in FIG. 2, the system 230, and the user input system 240 are each operatively and selectively connected to the network 210, which may include one or more separate networks. In addition, the network 210 may include a local area network (LAN), a wide area network (WAN), and/or a global area network (GAN), such as the Internet. The network may also include a mobile telecommunication network. It will also be understood that the network 210 may be secure and/or unsecure and may also include wireless and/or wireline and/or optical interconnection technology.

The user input system 240 may include any computerized apparatus that can be configured to perform any one or more of the functions of the user input system 240 described and/or contemplated herein. For example, the user 245 may use the user input system 240 to transmit and/or receive information or commands to and from the system 230. In some embodiments, for example, the user input system 240 may include a personal computer system, a mobile computing device, a personal digital assistant, a mobile phone, a network device, and/or the like. As illustrated in FIG. 2, in accordance with some embodiments of the present invention, the user input system 240 includes a communication interface 242, a processor 244, a memory 246 having an user application 247 stored therein, and a user interface 249. In such embodiments, the communication interface 242 is operatively and selectively connected to the processor 244, which is operatively and selectively connected to the user interface 249 and the memory 246. In some embodiments, the user 245 may use the user application 247 to execute processes described with respect to the process flows described herein.

Each communication interface described herein, including the communication interface 242, generally includes hardware, and, in some instances, software, that enables the user input system 240, to transport, send, receive, and/or otherwise communicate information to and/or from the communication interface of one or more other systems on the network 210. For example, the communication interface 242 of the user input system 240 may include a wireless transceiver, modem, server, electrical connection, and/or other electronic device that operatively connects the user input system 240 to another system such as the system 230. The wireless transceiver may include a radio circuit to enable wireless transmission and reception of information.

Each processor described herein, including the processor 244, generally includes circuitry for implementing the audio, visual, and/or logic functions of the user input system 240. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 247 of the memory 246 of the user input system 240.

Each memory device described herein, including the memory 246 for storing the user application 247 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 2, the memory 246 includes the user application 247. In some embodiments, the user application 247 includes an interface for communicating with, navigating, controlling, configuring, and/or using the user input system 240. In some embodiments, the user application 247 includes computer-executable program code portions for instructing the processor 244 to perform one or more of the functions of the user application 247 described and/or contemplated herein. In some embodiments, the user application 247 may include and/or use one or more network and/or system communication protocols.

Also shown in FIG. 2 is the user interface 249. In some embodiments, the user interface 249 includes one or more output devices, such as a display and/or speaker, for presenting information to the user 245. In some embodiments, the user interface 249 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 245. In some embodiments, the user interface 249 includes the input and display devices of a mobile device, which are operable to receive and display information.

FIG. 2 also illustrates a system 230, in accordance with an embodiment of the present invention. The system 230 may include any computerized apparatus that can be configured to perform any one or more of the functions of the system 230 described and/or contemplated herein. In accordance with some embodiments, for example, the system 230 may include a computer network, an engine, a platform, a server, a database system, a front end system, a back end system, a personal computer system, and/or the like. Therefore, the system 230 may be an external server as described herein. In some embodiments, such as the one illustrated in FIG. 2, the system 230 includes a communication interface 232, a processor 234, and a memory 236, which includes a system application 237 and a datastore 238 stored therein. As shown, the communication interface 232 is operatively and selectively connected to the processor 234, which is operatively and selectively connected to the memory 236.

It will be understood that the system application 237 may be configured to implement any one or more portions of the various user interfaces and/or process flow described herein. The system application 237 may interact with the user application 247. It will also be understood that, in some embodiments, the memory includes other applications. It will also be understood that, in some embodiments, the system application 237 is configured to communicate with the datastore 238, the user input system 240, etc.

It will be further understood that, in some embodiments, the system application 237 includes computer-executable program code portions for instructing the processor 234 to perform any one or more of the functions of the system application 237 described and/or contemplated herein. In some embodiments, the system application 237 may include and/or use one or more network and/or system communication protocols.

In addition to the system application 237, the memory 236 also includes the datastore 238. As used herein, the datastore 238 may be one or more distinct and/or remote datastores. In some embodiments, the datastore 238 is not located within the system and is instead located remotely from the system. In some embodiments, the datastore 238 stores information or data described herein.

It will be understood that the datastore 238 may include any one or more storage devices, including, but not limited to, datastores, databases, and/or any of the other storage devices typically associated with a computer system. It will also be understood that the datastore 238 may store information in any known way, such as, for example, by using one or more computer codes and/or languages, alphanumeric character strings, data sets, figures, tables, charts, links, documents, and/or the like. Further, in some embodiments, the datastore 238 may include information associated with one or more applications, such as, for example, the system application 237. It will also be understood that, in some embodiments, the datastore 238 provides a substantially real-time representation of the information stored therein, so that, for example, when the processor 234 accesses the datastore 238, the information stored therein is current or substantially current.

It will be understood that the embodiment of the system environment illustrated in FIG. 2 is exemplary and that other embodiments may vary. As another example, in some embodiments, the system 230 includes more, less, or different components. As another example, in some embodiments, some or all of the portions of the system environment 200 may be combined into a single portion. Likewise, in some embodiments, some or all of the portions of the system 230 may be separated into two or more distinct portions.

In addition, the various portions of the system environment 200 may be maintained for and/or by the same or separate parties. It will also be understood that the system 230 may include and/or implement any embodiment of the present invention described and/or contemplated herein. For example, in some embodiments, the system 230 is configured to implement any one or more of the embodiments of the process flow 100 described and/or contemplated herein in connection with FIG. 1 or any other process flow described herein. Additionally, the system 230 is configured to initiate presentation of any of the user interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for processing readable indicia for a payment claim associated with a merchant, the apparatus comprising:
a memory;
a processor; and
a computing module stored in the memory, executable by the processor, and configured to:
receive information associated with readable indicia associated with a payment claim;
receive authentication credentials associated with the payment claim; and
process the readable indicia and the authentication credentials to authorize a payment associated with the payment claim.

2. The apparatus of claim 1, wherein the readable indicia comprises a Quick Response (QR) code.

3. The apparatus of claim 1, wherein the readable indicia is comprised in a tag that transmits information wirelessly.

4. The apparatus of claim 1, wherein the merchant is an insurance entity.

5. The apparatus of claim 1, wherein the apparatus comprises a portable mobile communication apparatus that comprises an image-capturing component, and wherein an image of the readable indicia is captured by the portable mobile communication apparatus.

6. The apparatus of claim 5, wherein the processing occurs either inside or outside the portable mobile communication apparatus.

7. The apparatus of claim 5, wherein the authentication credentials are input by a user of the portable mobile communication apparatus.

8. The apparatus of claim 1, wherein the readable indicia comprises at least one of electronic readable indicia or physical readable indicia.

9. The apparatus of claim 8, wherein when the readable indicia comprises electronic readable indicia, the electronic readable indicia is generated dynamically based on user input.

10. The apparatus of claim 1, wherein the authentication credentials are first authentication credentials, and wherein second authentication credentials are comprised in the readable indicia.

11. The apparatus of claim 10, wherein the module is further configured to:
extract the second authentication credentials from the readable indicia; and
determine whether the first authentication credentials match the second authentication credentials.

12. The apparatus of claim 1, wherein the module is configured to:
determine whether the authentication credentials match second authentication credentials accessed by the apparatus.

13. The apparatus of claim 1, wherein the module is further configured to initiate an authentication prompt for receiving the authentication credentials in response to receiving the information associated with the readable indicia.

14. The apparatus of claim 1, wherein the module is further configured to:
extract a link from the readable indicia; and
initiate a user interface associated with the link.

15. The apparatus of claim 1, wherein the module is further configured to:
initiate issuance of the payment associated with the payment claim to an account or an alias.

16. The apparatus of claim 1, wherein the payment claim was previously submitted by a user to the merchant.

17. The apparatus of claim 15, wherein the payment is issued as an electronic stored value card.

18. A method for processing readable indicia for a payment claim, the method comprising:
receiving information associated with readable indicia associated with a payment claim;
receiving authentication credentials associated with the payment claim; and
processing the readable indicia and the authentication credentials to authorize a payment associated with the payment claim.

19. A computer program product for processing readable indicia for a payment claim, the computer program product comprising:
a non-transitory computer-readable medium comprising a set of codes for causing a computer to:
receive information associated with readable indicia associated with a payment claim;
receive authentication credentials associated with the payment claim; and
process the readable indicia and the authentication credentials to authorize a payment associated with the payment claim.
